(19) United States
(12) Patent Application Publication
(10) Pub. No.: US 2023/0356164 A1
(43) Pub. Date: Nov. 9, 2023

(54) FIXED-BED TUBULAR REACTOR

(71) Applicant: COMMISSARIAT À L'ÉNERGIE ATOMIQUE ET AUX ÉNERGIES ALTERNATIVES, Paris (FR)

(72) Inventors: Albin Chaise, Grenoble (FR); Alain Bengaouer, Grenoble (FR); Frédéric Ducros, Grenoble (FR)

(21) Appl. No.: 18/246,233

(22) PCT Filed: Sep. 22, 2021
(86) PCT No.: PCT/FR2021/051625

§ 371 Date: Mar. 22, 2023

(30) Foreign Application Priority Data
Sep. 29, 2020 (FR) 2009864

(51) Int. Cl. B01J 8/06; B01J 8/00

(52) U.S. Cl. CPC B01J 8/065; B01J 8/009; B01J 8/0085; B01J 2208/0092

(57) ABSTRACT

A tubular reactor comprises a catalytic powder bed confined in an annular space delimited by an inner wall and an outer wall, the insert comprises a distribution chamber and a collection chamber, separated by at least one first partition wall, the distribution chamber comprising distribution compartments separated from one another by second partition walls, each distribution compartment and the collection chamber comprising, respectively, an intake opening and a discharge opening, the inner wall comprises distributing openings and a collecting opening, each distributing opening enabling the distribution of a gas towards the annular space, and the collecting opening enabling the collection of the gas distributed in the annular space by the collection chamber.

### TECHNICAL FIELD

The present invention relates to the field of exchanger reactors. In particular, the present invention relates to the field of catalytic exchanger reactors implementing a solid catalyst, and in particular a solid catalyst in the form of powder.

In this respect, the present invention provides a catalytic exchanger reactor capable of implementing exothermic organic synthesis processes. In particular, these organic compounds may comprise synthetic fuels and a combustible.

### PRIOR ART

Catalytic reactors using solid catalysts are widely implemented for the synthesis of organic compounds such as synthetic fuels or combustibles, among which mention may be made of natural gas substitutes, dimethyl ether or methanol.

In particular, these compounds are obtained by reaction of hydrogen and carbon monoxide in the presence of a suitable solid catalyst.

Nonetheless, the chemical reactions relating to the synthesis of these compounds are very exothermic, and release an amount of heat likely to degrade the solid catalyst. In particular, this degradation of the solid catalyst is reflected by a deactivation of the latter, and leads to a reduction in the degree of conversion of the chemical species in presence. The selectivity of the involved reactions is also affected.

In practice, these reactions may be implemented in a shell-tube type reactor-exchanger which comprises a reactive channel provided with the solid catalyst and continuously cooled by a heat-transfer fluid. In this reactor type, the reactive gases circulate axially in the tubes which contain a catalyst, for example in the form of powder.

Nevertheless, despite the implementation of cooling by the heat-transfer fluid, this reactor type remains sensitive to the heat released by the reactions occurring in said reactor.

In particular, a hot spot, generally observed proximate to the reactive gas inlet, degrades the solid catalyst, and therefore reduces the performances of the reactor-exchanger.

In order to overcome these problems, an arrangement has then been proposed allowing splitting the distribution of the reagents over the entire length of the tubes. This solution then allows obtaining better temperature homogeneity over the entire length of the reactor.

In this respect, the documents U.S. Pat. Nos. 3,758,279, 4,374,094, EP0560157, IT8021172 and U.S. Pat. No. 2,997,374 propose reactor-exchangers implementing a distribution of the reagents from an annular distribution space. In particular, these reactor-exchangers, with a generally cylindrical shape, comprise, arranged coaxially and starting from the outside of the reactor, a tube, the annular distribution space, a catalyst charge and a collection space.

Nonetheless, this arrangement is not satisfactory.

Indeed, the presence of the annular distribution space disposed around the catalyst charge, limits the heat transfers from the catalyst to the tube making the generally considered cooling systems ineffective. Nevertheless, it remains possible to insert heat-conducting elements in the reactor. Nonetheless, such a solution remains incompatible with reactors comprising tubes with a small diameter.

Conversely, the document CN103990420 suggests implementing an insert provided with a distribution chamber and a collection chamber, disposed at the centre of a tube and defining with the latter an annular space accommodating the solid catalyst.

Nonetheless, the arrangement suggested in this document does not enable homogeneous distribution of the reagents within the annular space. More particularly, this arrangement does not allow obtaining an optimum temperature profile within the solid catalyst.

FIG. 1 of the document U.S. Pat. No. 8,961,909 represents another example of a shell-tube type reactor. In particular, this reactor is provided with an injection tube, immersed in a catalytic powder bed, and along which holes are formed. In particular, these are arranged so as to ensure injection of the reactive gas at different levels of the catalytic powder bed, and thus limit the apparition of hot spots in said bed.

Nonetheless, this reactor is not satisfactory.

Indeed, in order to ensure cooling thereof, this reactor requires the set-up of a plurality of circulation circuits of a heat-transfer fluid, which increase its complexity accordingly.

The document U.S. Pat. No. 7,402,719, in particular in FIG. 3a, discloses another example of a reactor arranged so as to enable a staged injection of a reagent C for reaction thereof with a reagent A. In this respect, this reactor comprises two layers (or channels) separated by a wall and intended to ensure the circulation of the reagent A and of the reagent C, respectively. Moreover, the two layers are in fluid communication by means of a plurality of holes formed in the wall separating them. In particular, these holes are arranged in order to ensure a progressive mixing of the reagent C with the reagent A. Thus, this progressive mixing allows limiting the apparition of hot spots. However, the arrangement of the reactor in the form of a stack of layers makes the latter barely compact.

The present invention aims to provide a fixed-bed tubular reactor enabling a more uniform distribution of the reagents within the solid catalyst.

The present invention also aims to provide a fixed-bed tubular reactor enabling a more homogeneous distribution of the heat flow generated within the solid catalyst.

The present invention also aims to provide a fixed-bed tubular reactor enabling better cooling management.

The present invention also aims to provide a fixed-bed tubular reactor for which the reliability and the service life are improved compared to the reactors known from the prior art.

The present invention also aims to provide a fixed-bed tubular reactor allowing optimising (increasing) the passage time of the gases in the fixed catalytic powder bed.

The present invention aims to provide a fixed-bed tubular reactor enabling a staged injection of one or more reagent(s) within the solid catalyst.

### DISCLOSURE OF THE INVENTION

The aims of the present invention are achieved, at least in part, by a fixed-bed tubular reactor which extends, according to a longitudinal axis XX′, between a first end and a second end, said reactor comprises a catalytic powder bed confined in an annular space delimited by an outer wall of a hollow tube and an inner wall of a hollow insert disposed coaxially in the hollow tube,

the hollow insert comprises at least one distribution chamber and at least one collection chamber, separated from one another by at least one first partition wall, the at least one distribution chamber comprising a plurality of distribution compartments separated from one another by one or more second partition wall(s), each distribution compartment and the at least one collection chamber comprising, respectively, a gas intake opening at the first end and a gas discharge opening at the second end,

the outer wall comprises distributing openings and at least one collecting opening, which extend over a length L, each distributing opening enabling the distribution of a gas capable of being admitted through an intake opening in a distribution compartment towards the annular space, and the collecting opening enabling the collection of the gas distributed in the annular space by the collection chamber.

Each distributing opening and/or each collecting opening may be formed by one single opening.

Alternatively, a distributing opening and/or a collecting opening may comprise a plurality of openings, for example aligned according to its direction of extension.

According to one implementation, said reactor comprises, at the first end and at the second end, respectively, a distributing space and a collecting space between which the hollow insert is disposed.

According to one implementation, the distribution compartments are sealed at the second end, and the at least one collection chamber is sealed at the first end.

According to one implementation, each distribution compartment is separated from the distributing space by a wall, called intake wall, in which the intake opening is formed.

According to one implementation, each intake opening is shaped so as to impose at a given flow rate a pressure drop on the gas capable of being admitted into the distribution compartment that is associated thereto.

According to one implementation, the pressure drop imposed by an intake opening is adjusted according to a distance, called reactive distance, measured in the annular space, between the distributing opening of the considered distribution compartment and the collecting opening the closest to said distributing opening.

According to one implementation, the pressure drop imposed by an intake opening is even higher as the reactive distance is short.

According to one implementation, the pressure drop associated with a given intake opening is adjusted by the size of said intake opening.

According to one implementation, a porous element is accommodated within the intake opening, the porous element having a porosity allowing imposing the pressure drop.

According to one implementation, the porous element may comprise at least materials selected from among: a fibrous material, in particular wool, a braid or a metal or ceramic fabric.

According to one implementation, the distributing space comprises a volumetric section into which the intake openings open, said volumetric section being connected to a gas supply duct.

According to one implementation, the distributing space comprises volumetric subsections at least one intake opening opens into each of which.

According to one implementation, the volumetric subsections form annular intake spaces disposed concentrically and separated by tight annular walls.

According to one implementation, several intake openings open into at least one of the volumetric subsections.

According to one implementation, each of the volumetric subsections is connected to a different gas intake duct.

According to one implementation, said reactor is provided with a porous film covering the inner wall, and arranged so as to prevent the passage of powder from the catalytic powder bed through the distributing openings or the collecting opening.

According to one implementation, the catalytic powder is retained in the annular space by a seal made of fibrous material at each of the ends of the annular space, advantageously, the seal made of fibrous material is held in compression against the catalytic powder by a spring, the spring abutting against a mechanically-linked holding plate of the tube.

According to one implementation, the second wall has no opening on a first section and a second section which extend from, respectively, the first end and the second end, the first section and the second section overlapping with the powder bed over a height H1, the height H1 being comprised between 0.2 times and 10 times, advantageously comprised between 1 times and 2 times, the distance D1 separating a distributing opening from an immediately adjacent collecting opening, and measured along the outer surface of the outer wall.

According to one implementation, the hollow insert is provided with centring means holding the latter in a position coaxial with the hollow tube, advantageously, the centring means comprise bosses formed on the second wall.

According to one implementation, the collecting opening and the distributing openings have a width comprised between 1/100 and ½, advantageously comprised between 1/20 and ¼, of the diameter of the hollow tube.

According to one implementation, the hollow insert forms a single-piece part.

### BRIEF DESCRIPTION OF THE DRAWINGS

Other features and advantages will become apparent in the following description of the fixed-bed tubular reactor according to the invention, given as non-limiting examples, with reference to the appended drawings wherein:

FIG. 1 is a schematic representation of a fixed-bed tubular reactor according to the present invention, in particular, FIG. 1 represents the reactor according to a longitudinal sectional plane passing through a longitudinal axis XX′ of said reactor;

FIG. 2 is a sectional view according to a transverse plane, perpendicular to the longitudinal axis XX′ of the tubular reactor of FIG. 1, according to this representation, the tubular reactor comprises two distribution chambers and two collection chambers, each distribution chamber is in particular divided into five distribution compartments arranged symmetrically with respect to the bisector plane P, the arrows symbolise the direction of circulation of the gas(es) in the annular space;

FIG. 3 is a sectional view according to a transverse plane, perpendicular to the longitudinal axis XX′ of the tubular reactor of FIG. 1, and illustrating intake openings with different sections;

FIG. 4 is a sectional view according to a transverse plane, perpendicular to the longitudinal axis XX′ of the tubular reactor of FIG. 1, and illustrating intake openings at which porous elements are accommodated;

FIG. 5 is a representation of the hollow insert according to the present invention, and provided with bosses for centring the hollow insert in the hollow tube;

FIG. 6 is a representation of a filter element, and in particular of a filter element formed by 4 fibre planes, capable of being implemented in the tubular reactor according to the present invention;

FIG. 7 is a schematic representation of a fixed-bed tubular reactor according to another example of the present invention, in particular, FIG. 7 represents the reactor according to a longitudinal sectional plane passing through a longitudinal axis XX′ of said reactor;

FIG. 8 is a representation according to a longitudinal sectional plane passing through a longitudinal axis XX′ of the distributing space according to a second variant of the present invention;

FIG. 9A is a view according to the sectional plane AA of FIG. 8;

FIG. 9B is a view according to the sectional plane BB of FIG. 8;

FIG. 9C is a view according to the sectional plane CC of FIG. 8;

FIG. 10 is a partial schematic representation (at the first end) of an arrangement provided with a plurality of tubular reactors according to the present invention.

### DETAILED DISCLOSURE OF PARTICULAR EMBODIMENTS

The present invention relates to a tubular reactor-exchanger with a fixed catalytic powder bed. In particular, the catalytic powder bed is confined in an annular space delimited by a wall, called outer wall, of a hollow tube and another wall, called inner wall, of a hollow insert accommodated coaxially in said tube.

According to the present invention, the hollow insert comprises at least one distribution chamber and at least one collection chamber, separated from one another by at least one first partition wall. Moreover, the at least one distribution chamber comprises a plurality of distribution compartment separated from one another by one or more second partition wall(s). Each distribution compartment and the at least one collection chamber comprise, respectively, a gas intake opening at the first end and a gas discharge opening at the second end.

It should be understood that the presence of a gas intake opening at the first end implies that said opening is arranged so as to enable the gas admission through the first end. In other words, the gas intake opening may be disposed on the first end.

Equivalently, the presence of a gas discharge opening at the second end implies that said opening is arranged so as to enable the gas discharge through the second end. In other words, the gas discharge opening may be disposed on the second end.

The inner wall comprises distributing openings and at least one collecting opening, which extend over a length L. Each distributing opening enables the distribution of a gas capable of being admitted through an intake opening in a distribution compartment towards the annular space, and the collecting opening enables the collection of the gas distributed in the annular space by the collection chamber.

The implementation of a plurality of distribution compartments allows splitting the distribution of reactive gas, from the same distribution chamber, at different locations of the catalytic powder bed. Thus, this mode of distribution limits the apparition of hot spots and preserves the performances of the catalytic powder bed.

Equivalently, the multiplicity of the distribution compartments allows considering the distribution of gases or mixtures of gases of different natures in the annular space. This last aspect allows controlling the reactions involved in the powder bed, and in particular their selectivity.

The advantages associated with the different aspects of the present invention will appear more clearly upon reading the following detailed description.

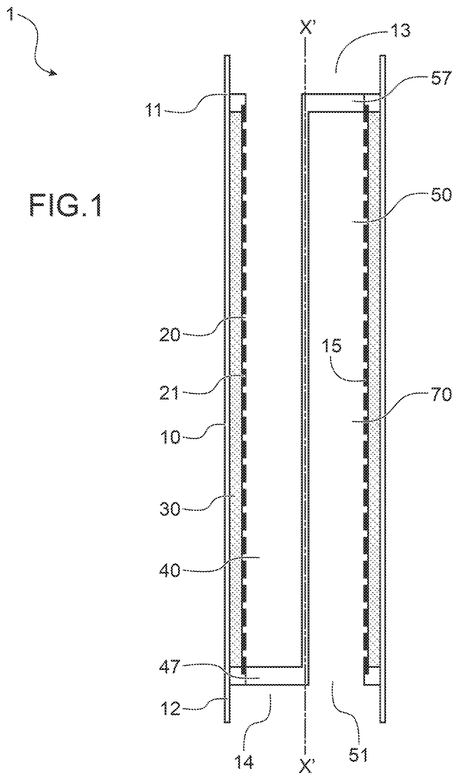

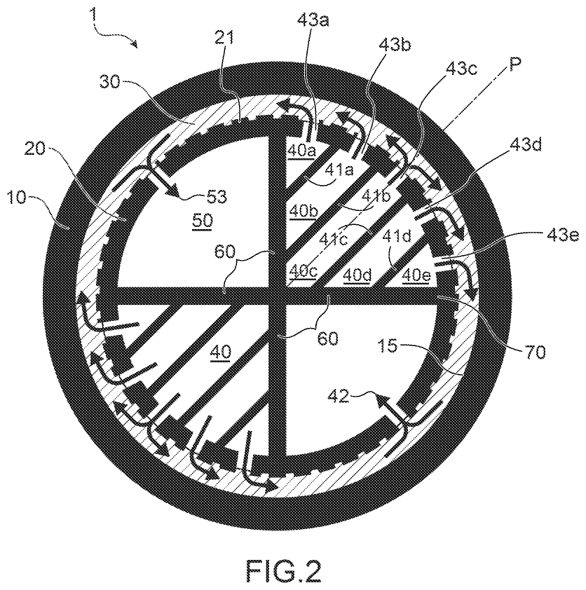

Thus, in FIGS. 1 and 2, an embodiment of a fixed-bed tubular reactor according to the present invention is shown.

The tubular reactor 1 according to the present invention comprises a hollow tube which extends according to a longitudinal axis XX′, between a first end 11 and a second end 12. The hollow tube 10 may have an axisymmetry around the longitudinal axis XX′. It should be understood that the longitudinal axis XX′ may be an axis of revolution of the hollow tube 10.

The hollow tube 10 may comprise a metal, and in particular a metal selected from among: steel, aluminium, copper, nickel alloy.

The diameter of the inner surface of the hollow tube may be comprised between 5 mm and 100 mm.

The wall, called outer wall 15, forming the hollow tube 10 may have a thickness comprised between 0.5 mm and 10 mm.

The hollow tube 10 may have a length comprised between 10 times and 200 times the diameter of the inner surface.

The tubular reactor 1 also comprises a hollow insert 20 which also extends according to the longitudinal axis XX′ and has a generally cylindrical shape.

In particular, the hollow insert 20 is accommodated in the volume V of the hollow tube coaxially with the latter. In particular, the insert 20 also comprises a wall, called inner wall 21, which delimits with the outer wall 15 an annular space 30.

In this respect, the annular space 30 is filled with a catalytic powder, and will be the site of the reactions of conversion of reactive gases likely to transit through the tubular reactor 1.

The annular space 30 may have a thickness, defined as the distance between the outer wall 15 and the inner wall 21, comprised between 2% and 20% of the diameter of the inner surface of the hollow tube 10.

The hollow insert 20 may be a single-piece part.

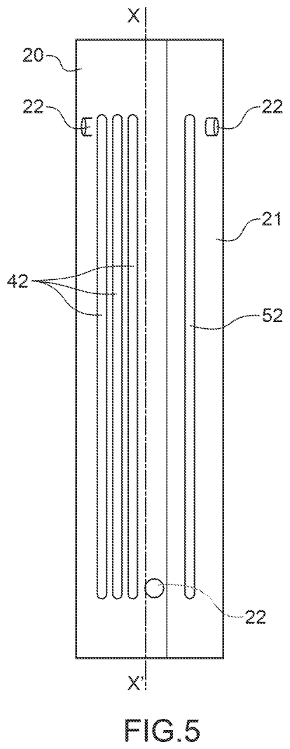

In a particularly advantageous manner, the hollow insert 20 may be provided with centring means holding the latter in a position coaxial with the hollow tube. For example, as represented in FIG. 5 the centring means comprise bosses 22 formed over the inner wall.

In particular, these centring means allow considering a hollow insert with a length at least 20 times larger than the diameter of said insert.

Moreover, these means also allow facilitating mounting of the tubular reactor 1.

Moreover, the hollow insert 20 comprises at least one distribution chamber 40 and at least one collection chamber 50. In particular, the hollow insert 20 may comprise between 1 and 4 distribution chambers 40 and between 1 and 4 collection chambers 50.

Advantageously, the at least one distribution chamber 40 and the at least one collection chamber 50 are disposed alternately, and extend over the entire length of the hollow insert 20. Moreover, the at least one collection chamber 50 and the at least one distribution chamber 40 are separated from each other by first partition walls 60. Hence, it should be understood that a distribution chamber 40 is delimited by two partition walls 60 and a section of the inner wall 21.

Equivalently, a collection chamber 50 is also delimited by two first partition walls 60 and another section of the inner wall 21.

Moreover, the first partition walls 60 extend over the entire length of the hollow insert in the volume defined by the hollow insert 20, and are arranged so as to prevent any direct passage of gas from one chamber to another.

For example, the first partition walls 60 form planes passing through the longitudinal axis XX′. In particular, the two first partition walls 60 of a distribution chamber may have a generally elongate shape and extend according to the longitudinal axis XX′ from the first end 11 towards the second end 12. In particular, the two first partition walls 60 of a distribution chamber 40 may have a common side coincident with the longitudinal axis XX′. Moreover, it should be understood that the two first walls 60 of a distribution chamber 40 may be coplanar, in particular when the hollow insert 20 comprises a unique distribution chamber 40.

Moreover, each distribution chamber 40 comprises a plurality of distribution compartments 40a, 40b, 40c, 40d and 40e, separated from one another by one or more second partition wall(s) 41a, 41b, 41c and 41d arranged so as to prevent any direct passage of gas from one compartment to another.

Advantageously, the second partition walls 41a, 41b, 41c and 41d may be parallel to one another, and more particularly be parallel to a bisector plane P of the first walls 60 delimiting the distribution chamber 40.

According to this configuration, the distribution compartments 40a, 40b, 40c, 40d and 40e extend from the first end 11 towards the second end 12.

More particularly, and still according to this configuration, the distribution compartments 40a, 40b, 40c, 40d and 40e form a symmetrical arrangement with respect to the bisector plane P.

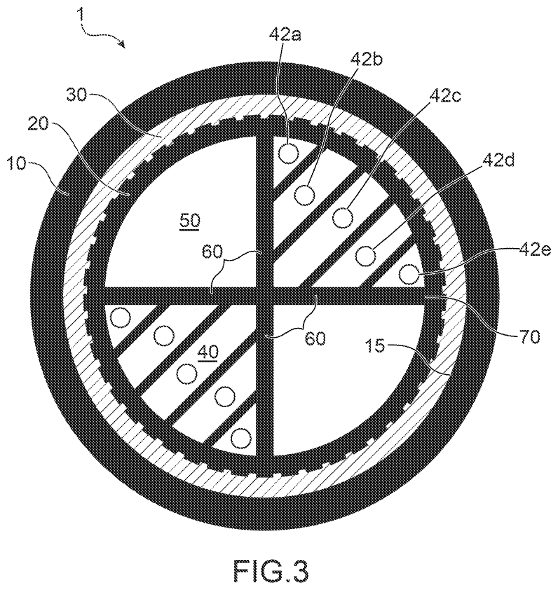

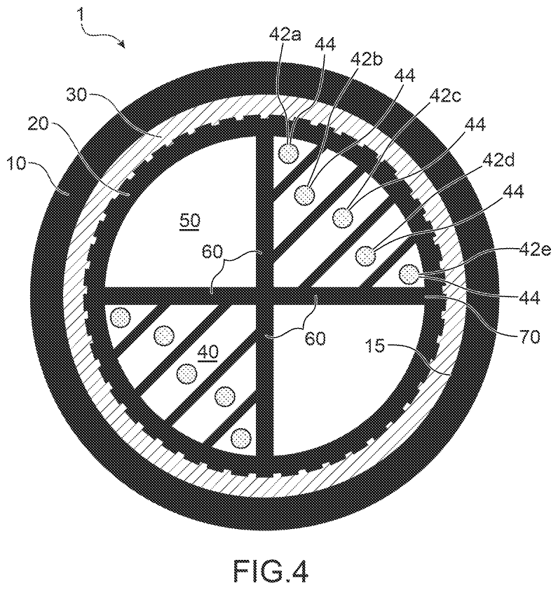

Each distribution compartment 40a, 40b, 40c, 40d and 40e comprises a gas intake opening 42a, 42b, 42c, 42d and 42e at the first end 11 (FIGS. 1 and 3) of said insert 20 through which one or more reactive gas(es) can be admitted.

Equivalently, the at least one collection chamber 50 comprises a discharge opening 51 at the second end 12 of the hollow insert 20 and through which one or more gas(es) can be discharged (FIG. 1).

Moreover, the distribution chambers 40a, 40b, 40c, 40d and 40e are sealed at the second end 12, and the at least one collection chamber 50 is sealed at the first end 11.

The hollow insert 20 is also provided with a plurality of distributing openings 43a, 43b, 43c, 43d and 43e which extend continuously, or not, over a length L, and advantageously parallel to the longitudinal axis XX′.

Each distributing opening may be formed by one single opening,

Alternatively, a distributing opening may comprise a plurality of openings, for example aligned according to its direction of extension.

In particular, each of these distributing openings 43a, 43b, 43c, 43d and 43e forms one or more passage(s) in the inner wall 21, and is associated with a different distribution compartment 40a, 40b, 40c, 40d and 40e. In particular, each distributing opening 43a, 43b, 43c, 43d and 43e is arranged so as to enable the distribution in the annular space 30 of a gas capable of being admitted, through an intake opening 42a, 42b, 42c, 42d and 42e, into the distribution compartment 40a, 40b, 40c, 40d and 40e to which it is associated.

The hollow insert 20 also comprises at least one collecting opening 53, which extends over a length L, and advantageously parallel to the longitudinal axis XX′. In particular, the at least one collecting opening 53 forms a passage in the inner wall 21, and is associated to the at least one collection chamber 50. In particular, the at least one collecting opening 53 is arranged so as to enable the collection, by the collection chamber 50, of a gas distributed in the annular space 30.

Each collecting opening may be formed by one single opening,

Alternatively, a collecting opening may comprise a plurality of openings, for example aligned according to its direction of extension.

Thus, the distributing opening 43a, 43b, 43c, 43d and 43e, of a distribution compartment 40a, 40b, 40c, 40d and 40e, enables the distribution of a gas capable of being admitted, through the intake opening 42a, 42b, 42c, 42d and 42e, into said compartment towards the annular space 30.

Equivalently, the collecting opening 53 enables the collection of the gas distributed in the annular space 30, by the collection chamber 50.

Thus, the multiplicity of the distributing openings associated with a given distribution chamber allows injecting one or more reactive gas(es) into the annular space at different areas of said space 30. This distribution of the gas injection areas allows replicating the principle of staged injection and thus limiting the apparition of local heat-up (hot spots) at the annular area 30. This limitation of heat-up also prevents the phenomena of sintering of the catalytic powder present in the annular space.

Considering a plurality of distributing openings 40a, 40b, 40c, 40d and 40e per distribution chamber 40 allows considering a hollow insert 20 limited to one single, and possibly two, distribution chamber(s). Moreover, such an arrangement allows simplifying the manufacture of the hollow insert 20.

The extension of the distributing openings 43a, 43b, 43c, 43d and 43e over the length L also allows spreading out the injection of gas into the annular space 30 and thus limiting the apparition of hot spots.

Advantageously, the collecting openings 43a, 43b, 43c, 43d and 43e may have a width comprised between 1/100 and ½, advantageously comprised between 1/20 and ¼, of the diameter of the hollow tube 10.

Advantageously, the distributing openings 43a, 43b, 43c, 43d and 43e of a given distribution chamber 40 may be arranged symmetrically with respect to a bisector plane P of the walls 60 delimiting said chamber (FIG. 2).

Thus, during the operation of the tubular reactor 1, a gas is admitted through the intake openings 42a, 42b, 42c, 42d and 42e in each of the distribution compartments 40a, 40b, 40c, 40d and 40e. This gas is then distributed in the annular space 30 through each of the distributing openings 43a, 43b, 43c, 43d and 43e, and is then collected through the collecting opening(s) 53.

The path of the gas in the annular space 30 depends on the relative positioning of the intake openings 42a, 42b, 42c, 42d and 42e and of the collecting opening(s) 53. In particular, and as illustrated by the arrows in FIG. 2, the gas distributed through a given distributing opening, is primarily collected through the collecting opening 53 that is the closest to said distributing opening. By “collection opening that is the closest to said distributing opening”, it should be understood the collecting opening that is associated to the shortest reactive path of the gas compared to the other collecting openings. In other words, the collecting opening that is the closest to said distributing opening is none other than the first collecting opening that the gas encounters during its circulation in the annular space 30.

The tubular reactor 1 may comprise at the first end 11 and at the second end 12, respectively, a distributing space 13 and a collecting space 14 between which the hollow insert 20 is disposed (FIG. 1).

In this respect, each distribution compartment 40a, 40b, 40c, 40d and 40e is separated from the distributing space 13 by a wall, called intake wall 44 in which the intake opening 42a, 42b, 42c, 42d and 42e is formed (FIG. 3).

According to an advantageous embodiment, each intake opening 42a, 42b, 42c, 42d and 42e is shaped so as to impose a pressure drop on the gas capable of being admitted into the distribution compartment 40a, 40b, 40c, 40d and 40e which depends on a distance, called reactive distance, actually covered by said gas in the annular space 30.

In this respect, the reactive distance depends on the considered compartment, and in particular the distance between the collecting opening of said compartment and the closest collecting opening 52. In particular, the intake opening 42a, 42b, 42c, 42d and 42e of a given distribution compartment 40a, 40b, 40c, 40d and 40e may be shaped so as to impose a pressure drop that is even higher as the distance between the distributing opening of said compartment and the closest collecting opening, is short.

Advantageously, and as illustrated in FIG. 3, the pressure drop associated to a given intake opening is adjusted by its section. More particularly, the pressure drop imposed by an intake opening increases as its section decreases (the section of an opening, according to the present invention, is none other than the surface or the extent of said opening).

Alternatively or complementarily, and as illustrated in FIG. 5, the pressure drop at one intake opening 42a, 42b, 42c, 42d and 42e may be imposed by a porous element 44 accommodated within said intake opening 42a, 42b, 42c, 42d and 42e. In particular, each porous element 44 has a porosity allowing imposing a predetermined pressure drop on a given gas flow rate.

In this respect, the porous element may comprise at least one of the materials selected from among: a fibrous material, in particular wool, a braid or a metallic or ceramic fabric.

Considering a pressure drop adjusted according to the reactive distance allows better splitting and control of the gas flows in the annular space. Considering so results in a better optimisation of the phenomena of local heat-up of the catalytic powder bed, and consequently an improvement in the performances of said bed.

However, the invention is not limited just to the adjustment of the pressure drop imposed at the intake openings. Indeed, based on the element hereinbefore, a person skilled in the art can also consider, alternatively or complementarily, imposing a pressure drop at the distributing openings.

Advantageously, the tubular reactor 1 comprises a filter arranged so as to prevent the passage of the catalytic powder into the distribution compartments or the collection chamber.

For example, as illustrated in FIG. 2, a filter 70 may be disposed overlapping the inner wall 21.

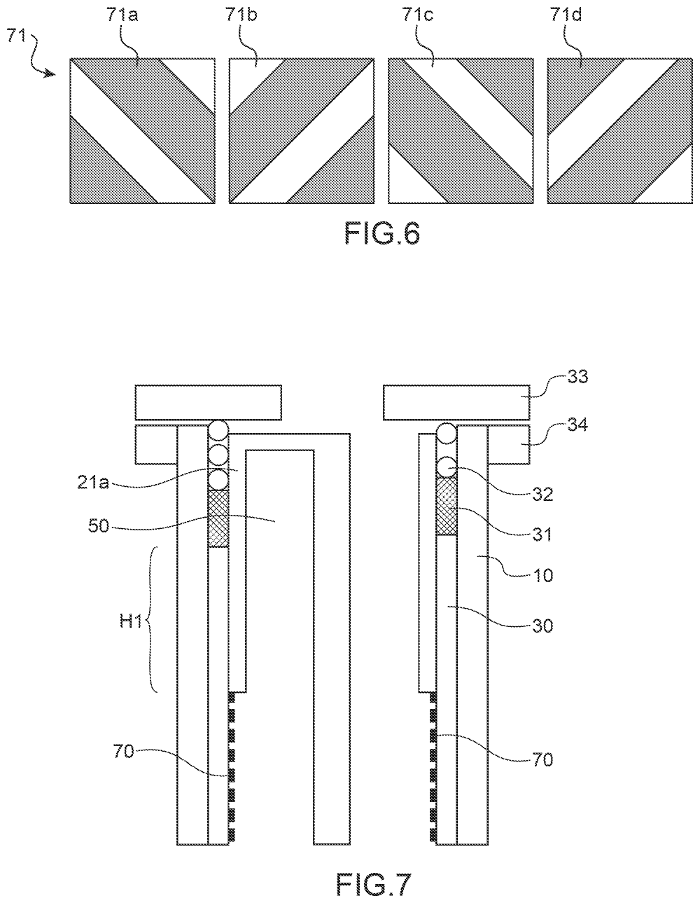

Alternatively, the filter may comprise filter elements 71 accommodated within the distributing openings and the collecting openings. A filter element 71 may comprise a plurality of planes 71a, 71b, 71c and 71d comprising fibres. The example illustrated in FIG. 6 comprises in particular 4 planes, each provided with rectangular or round fibres and inclined at +/−45° with respect to the longitudinal axis XX′. More particularly, the fibres of two successive planes are oriented according to two different angles, and are in particular perpendicular from one plane to another.

According to a particularly advantageous aspect illustrated in FIG. 7, the catalytic powder is retained in the annular space 30 by a seal 31, for example made of fibrous material, at each of the ends of said annular space 30.

To the extent that the seal is made of fibrous material, the latter is necessarily porous and therefore permeable to reactive gases.

In this respect, the fibrous material may comprise at least one of the elements selected from among: fibreglass, ceramic fibre, metal fibre, carbon fibre, polymer material fibre.

In particular, the seal 31 may be in the form of a braid, a sheath, a cord or simply comprise a stuffing of the fibrous material.

Advantageously, the fibrous material is a thermal insulator and has a thermal conductivity substantially equivalent to that of the used catalyst (0.2 W/m/K to 10 W/m/K).

According to an advantageous embodiment, the seal 31 made of fibrous material is held in compression against the catalytic powder by a spring 32. For example, the spring 32 abuts against a retaining plate 33 mechanically linked to the tube by a ring 34.

The seal 31 made of fibrous material in combination with the spring(s) allows better compacting the catalytic powder and preventing the attrition of the latter during handling or transport of the reactor.

To the extent that the seal 31 is porous, the reactive gases can enter the annular space directly without passing through the distribution compartments.

In this case (FIG. 7), it is particularly advantageous to provide for an arrangement of the hollow insert 20 allowing imposing on this reactive gas a predetermined pathway in the annular space in order to promote conversion thereof in contact with the catalytic powder bed. This predetermined path has a length comprised between 0.2 times and 10 times, advantageously comprised between 1 time and 2 times, the reactive path defined before.

To this end, the inner wall 21 may be devoid of openings over a first section 21a and a second section which extend starting from the first end 11 and the second end 12, respectively.

In this respect, the first section 21a and the second section overlap with the powder bed over a height H1. The height H1 being comprised between 0.5 times and 10 times, advantageously between one time and 2 times, the reactive distance.

As described before, the admission of gases is performed at the distributing space. In this respect, according to a first variant, the latter may be arranged so as to enable the admission of the same gas into each of the distribution compartments, or, according to a second variant, to enable the admission of gases that are different from one compartment to another.

According to the first variant (FIG. 1), the distributing space 13 comprises a volumetric section into which all intake openings open. According to this first variant, the volumetric section is connected to a gas supply duct. In other words, all distribution compartments 40a, 40b, 40c, 40d and 40e are supplied with the same gas or gas mixture.

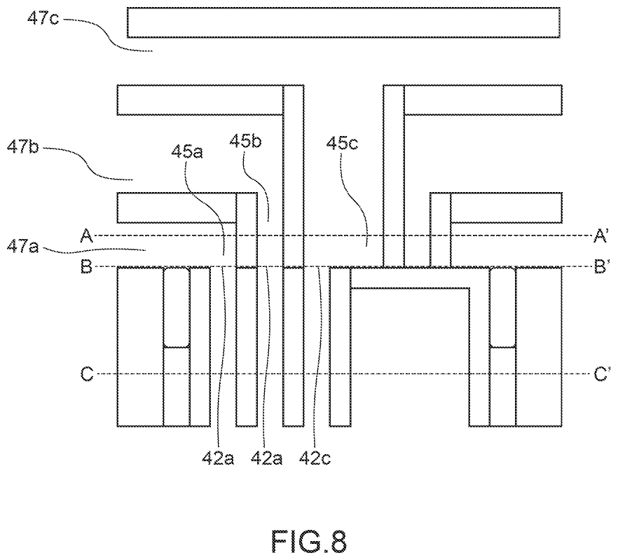

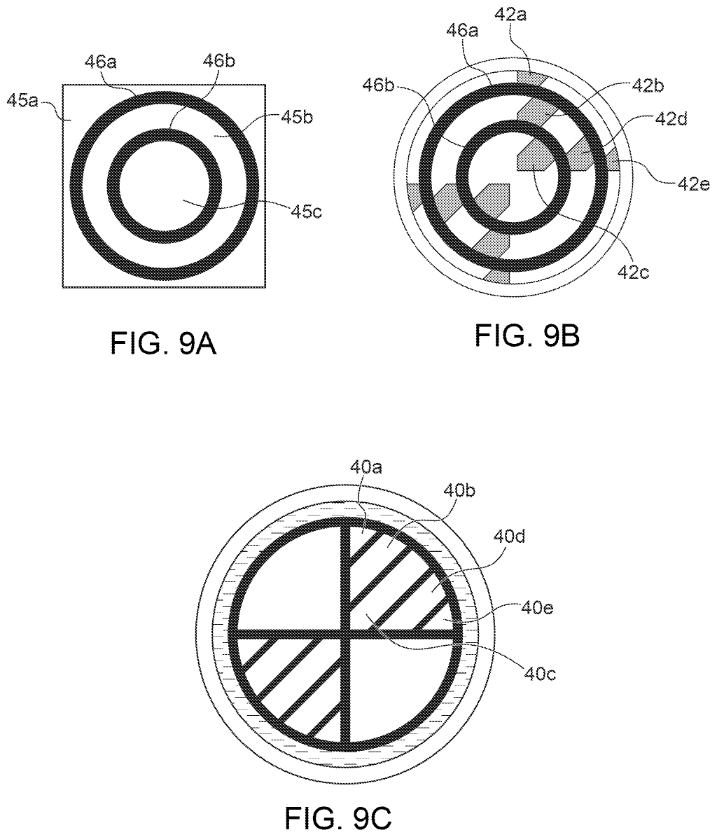

According to the second variant illustrated in FIGS. 8, 9A, 9B and 9C, the distributing space 13 comprises volumetric subsections 45a, 45b and 45c at least one intake opening 42a, 42b, 42c, 42d and 42e opens into each of which. Advantageously, the volumetric subsections 45a, 45b and 45c form annular intake spaces disposed concentrically and separated by tight annular walls 46a, 46b (FIGS. 9A et 9B).

Advantageously, several intake openings 42a, 42b, 42c, 42d and 42e may open into at least one of the volumetric subsections. For example, the intake openings 42a, 42b, 42c, 42d and 42e associated to distribution compartments 40a, 40b, 40c, 40d and 40e imposing on the gas the same reactive distance may open into the same volumetric subsection. In particular, as represented in FIG. 9B, the intake openings 42a and 42c open into the volumetric subsection 45a, the intake openings 42b and 42d into the volumetric subsection 45b, and the intake opening 42c into the volumetric subsection 45c.

Advantageously, each of the volumetric subsections 45a, 45b and 45c may be connected to a different gas intake duct. In particular, the volumetric subsections 45a, 45b and 45c are connected, respectively, to a first duct 47a, a second duct 47b and a third duct 47c (FIG. 8).

Thus, according to this second variant, it is possible to consider the injection of different gases or different gas mixtures into the distribution compartments.

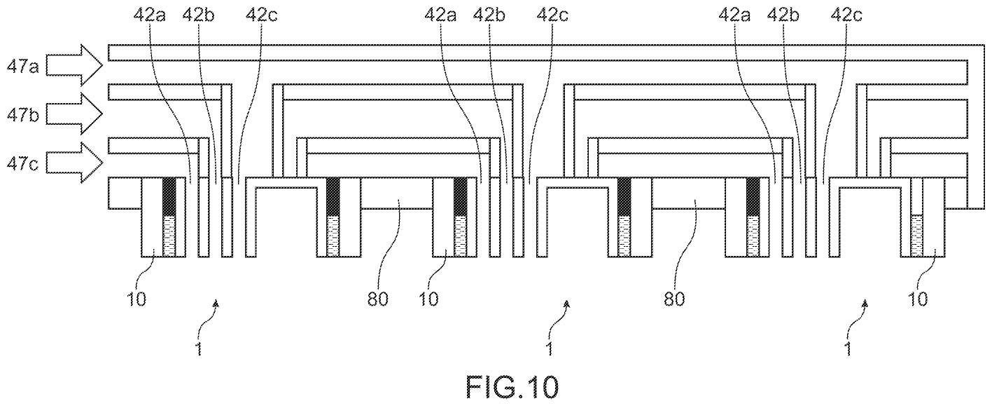

FIG. 10 is an illustration of the implementation of a plurality of tubular reactors 1 according to the present invention, and in particular according to the second variant (nevertheless, it should be understood that the first variant may also be considered). In particular, this implementation comprises 3 tubular reactors 1 disposed parallel to one another within one shell. In particular, tubular holding plates 80 allow holding the tubular reactors, and forming a space for the circulation of a heat-transfer fluid intended for cooling down the tubular reactors 1.

Moreover, all tubular reactors may be supplied with gas through the same supply ducts: the supply ducts 47a, 47b and 47c.

In particular, and as represented in FIG. 10, the duct 47a in particular connected to the volumetric subsection 45a of each of the reactors 1, the duct 47b in particular connected to the volumetric subsection 45b of each of the reactors 1, and the duct 47c in particular connected to the volumetric subsection 45c of each of the reactors 1.

The tubular reactor according to the present invention, and in particular the implementation of compartments in the distribution chamber(s), allows considering a staged distribution of the gases and gas mixtures in the annular space.

Thus, this configuration positively addresses the problem of heat-up of the catalytic powder, and thus limits the apparition of hot spots. This results in a more effective and more durable device.

Furthermore, the arrangement of the catalytic powder in the annular space facilitates cooling of the latter.

Advantageously, the tubular reactor according to the present invention is implemented for the synthesis of methane, methanol, dimethyl ether or to implement the Fisher-Tropsch synthesis.

The hollow insert may be manufactured in the form of a one-piece part according to an additive manufacturing process (for example a 3D manufacturing process). These manufacturing processes pave the way for the formation of parts with complex shapes, in particular the formation of a one-piece part comprising the distributing space, the collecting space, and the hollow insert.

Alternatively, the hollow insert may be an independent element assembled with a distributing space, formed by a first end body, and a collecting space, formed by a second end body.

The assembly may involve the implementation of seals interposed between each of the end bodies and the hollow insert.

What is claimed is:

1. A fixed-bed tubular reactor which extends, according to a longitudinal axis, between a first end and a second end, said reactor comprises a catalytic powder bed confined in an annular space delimited by an inner wall of a hollow tube and an outer wall of a hollow insert disposed coaxially in the hollow tube,
the hollow insert comprises at least one distribution chamber and at least one collection chamber, separated from one another by at least one first partition wall, the at least one distribution chamber comprising a plurality of distribution compartments separated from one another by one or more second partition wall(s), each distribution compartment and the at least one collection chamber comprising, respectively, a gas intake opening at the first end and a gas discharge opening at the second end,
the inner wall comprises distributing openings and at least one collecting opening, which extend over a length, each distributing opening enabling the distribution of a gas capable of being admitted through an intake opening into a distribution compartment towards the annular space and the collecting opening enabling the collection of the gas distributed in the annular space by the collection chamber.

2. The reactor according to claim 1, wherein said reactor comprises, at the first end and at the second end, respectively, a distributing space and a collecting space between which the hollow insert is disposed.

3. The reactor according to claim 2, wherein the distribution chambers are sealed at the second end, and the at least one collection chamber is sealed at the first end.

4. The reactor according to claim 2, wherein each distribution compartment is separated from the distributing space by a wall, called intake wall, in which the intake opening is formed.

5. The reactor according to claim 4, wherein each intake opening is shaped so as to impose a pressure drop on the gas capable of being admitted into the distribution compartment that is associated thereto.

6. The reactor according to claim 5, wherein the pressure drop imposed by an intake opening is adjusted according to a distance, called reactive distance, measured in the annular space, between the distributing opening of the considered distribution compartment and the collecting opening the closest to said distributing opening.

7. The reactor according to claim 6, wherein the pressure drop imposed by an intake opening is even higher as the reactive distance is short.

8. The reactor according to claim 7, wherein the pressure drop associated to a given intake opening is adjusted by the size of said intake opening.

9. The reactor according to claim 7, wherein a porous element is accommodated within the intake opening, the porous element having a porosity allowing imposing the pressure drop.

10. The reactor according to claim 9, wherein the porous element may comprise at least one of the materials selected from among: a fibrous material, in particular wool, a braid or a metal or ceramic fabric.

11. The reactor according to claim 2, wherein the distributing space comprises a volumetric section into which the intake openings open, said volumetric section being connected to a gas supply duct.

12. The reactor according to claim 2, wherein the distributing space comprises volumetric subsections at least one intake opening opens into each of which.

13. The reactor according to claim 12, wherein the volumetric subsections form annular intake spaces disposed concentrically and separated by tight annular walls.

14. The reactor according to claim 13, wherein several intake openings open into at least one of the volumetric subsections.

15. The reactor according to claim 14, wherein each of the volumetric subsections is connected to a different gas intake duct.

16. The reactor according to claim 1, wherein said reactor is provided with a porous film covering the inner wall, and arranged so as to prevent the passage of powder from the catalytic powder bed through the distributing openings and/or the collecting opening.

17. The reactor according to claim 1, wherein the catalytic powder is retained in the annular space by a seal made of fibrous material at each of the ends of the annular space, the seal made of fibrous material is held in compression against the catalytic powder by a spring, the spring abutting against a mechanically-linked holding plate of the tube.

18. The reactor according to claim 1, wherein the inner wall has no opening on a first section and a second section which extend from, respectively, the first end and the second end, the first section and the second section overlapping with the powder bed over a height, the height being comprised between 0.2 times and 10 times, the distance separating a distributing opening from an immediately adjacent collecting opening, and measured along the outer surface of the outer wall.

19. The reactor according to claim 1, wherein the hollow insert is provided with centring means holding the latter in a position coaxial with the hollow tube, the centring means comprise bosses formed on the second wall.

20. The reactor according to claim 1, wherein the collecting opening and the distributing openings have a width comprised between 1/100 and ½, of the diameter of the hollow tube.

21. The reactor according to claim 1, wherein the hollow insert forms a single-piece part.
